(19) United States
(12) Patent Application Publication
(10) Pub. No.: US 2020/0108824 A1
(43) Pub. Date: Apr. 9, 2020

(54) MONITORING AND ADJUSTMENT OF VEHICLE PARKING POSITIONS

(71) Applicant: Ford Global Technologies, LLC, Dearborn, MI (US)

(72) Inventors: Timothy C. Bettger, Aachen (DE); Thomas Gerlitz, Aachen (DE)

(21) Appl. No.: 16/152,037

(22) Filed: Oct. 4, 2018

(51) Int. Cl. B60W 30/06; G05D 1/02; G01S 19/13

(52) U.S. Cl. CPC B60W 30/06; G05D 1/0231; G08G 1/0967; G01S 19/13; G05D 2201/0213; G05D 1/0278

(57) ABSTRACT

Method and apparatus are disclosed for monitoring and adjustment of vehicle parking positions. An example vehicle includes range-detection sensors, a communication module, and a controller. The controller is to identify a wakeup frequency for the range-detection sensors. The controller also is to, when the vehicle is in a key-off state, temporarily activate the range-detection sensors at the wakeup frequency and determine whether to adjust a parking position based on the range-detection sensors. The controller also is to, responsive to determining to adjust the parking position, send a notification to a user via the communication module.

### TECHNICAL FIELD

The present disclosure generally relates to vehicle parking and, more specifically, to monitoring and adjustment of vehicle parking positions.

### BACKGROUND

Oftentimes, vehicles are parked in public areas. For instance, a vehicle may be parked in a parallel parking spot along a side of a road. In other instances, a vehicle may be parked in a perpendicular parking spot and/or an angled parking spot within a parking lot and/or a parking garage. Oftentimes, parking spots (e.g., parallel parking spots, perpendicular parking spots, angled parking spots) within public areas are not utilized efficiently. For instance, one vehicle potentially may intentionally and/or unintentionally take up two parking spots.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for monitoring and adjustment of vehicle parking positions. An example disclosed vehicle includes range-detection sensors, a communication module, and a controller. The controller is to identify a wakeup frequency for the range-detection sensors. The controller also is to, when the vehicle is in a key-off state, temporarily activate the range-detection sensors at the wakeup frequency and determine whether to adjust a parking position based on the range-detection sensors. The controller also is to, responsive to determining to adjust the parking position, send a notification to a user via the communication module.

Some examples further include an ignition switch sensor to detect an operating state of the vehicle. In some examples, the controller is configured to identify the wakeup frequency when the vehicle is in park and in a key-on state. Some such examples further include a transmission sensor to detect when the vehicle is in park.

In some examples, one or more of the range-detection sensors is selected from a group consisting of a proximity sensor and a camera.

Some examples further include a GPS receiver to identify a vehicle location. In such examples, the controller determines the wakeup frequency for the range-detection sensors based on the vehicle location. In some such examples, the controller is configured to increase the wakeup frequency for high-traffic areas and decrease the wakeup frequency for low-traffic areas. Further, in some such examples, the communication module is configured to communicate with a remote server to identify a traffic density of the vehicle location. In some such examples, the controller is configured to increase the wakeup frequency when the vehicle location corresponds with at least one of a home location and a work location of the user. In some such examples, the controller determines the wakeup frequency for the range-detection sensors further based on a time-of-day.

Some examples further include an autonomy unit to perform autonomous motive functions to adjust the parking position of the vehicle. In some such examples, the autonomy unit is configured to adjust the parking position in response to the user returning within a predetermined distance of the vehicle after receiving the notification.

In some examples, when the parking position is a parallel parking position, the controller is configured to determine, via the range-detection sensors, a first length of a first open space behind the vehicle and a second length of a second open space in front of the vehicle. In some such examples, the controller determines to adjust the parking position to create an additional parking spot in response to identifying that moving the vehicle forward or in reverse increases the first length or the second length to equal or exceed a predefined length of a standard parking spot. In some such examples, the controller determines to adjust the parking position to increase a buffer distance in response to identifying that moving the vehicle forward or in reverse increases the first length or the second length to equal the buffer distance without decreasing the other of the first length or the second length below a predefined length of a standard parking spot.

In some examples, when the parking position corresponds with a perpendicular or angled parking spot, the controller is configured to monitor bordering parking spots via the range-detection sensors. In some such examples, the controller determines to adjust the parking position in response to determining at least one of the bordering parking spots is unoccupied and the vehicle is not positioned fully within border lines of the perpendicular or angled parking spot. Further, some such examples further include an autonomy unit configured to autonomously perform reverse, turning, and forward motive functions to reposition the vehicle fully within the perpendicular or angled parking spot.

An example disclosed method includes identifying, via a processor, a wakeup frequency for range-detection sensors of a vehicle and, when the vehicle is in a key-off state, temporarily activating the range-detection sensors at the wakeup frequency. The example disclosed method also includes determining whether to adjust a parking position of the vehicle based on the range-detection sensors and sending, via a communication module of vehicle, a notification to a user responsive to determining to adjust the parking position.

In some examples, the wakeup frequency for the range-detection sensors is determined based on a current location of the vehicle.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIGS. 2A-2C depict an example parallel parking scenario of the vehicle of FIG. 1.

FIGS. 3A-3C depict another example parallel parking scenario of the vehicle of FIG. 1.

FIGS. 4A-4C depict an example angled parking scenario of the vehicle of FIG. 1.

FIG. 5 is a block diagram of electronic components of the vehicle of FIG. 1.

FIG. 6 is a flowchart for monitoring and adjusting a vehicle parking position in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Oftentimes, vehicles are parked in public areas. For instance, a vehicle may be parked in a parallel parking spot along a side of a road. In other instances, a vehicle may be parked in a perpendicular parking spot and/or an angled parking spot within a parking lot and/or a parking garage. Oftentimes, parking spots (e.g., parallel parking spots, perpendicular parking spots, angled parking spots) within public areas are not utilized efficiently. For instance, one vehicle potentially may intentionally and/or unintentionally take up two parking spots. In some instances, when a vehicle is parked, the vehicle potentially may be (1) initially positioned in a space-efficient matter and (2) subsequently positioned in a space-inefficient matter after other nearby vehicle(s) have moved.

Example methods and apparatus disclosed herein intermittently monitor a surrounding area of a parked vehicle to identify whether a parking position of the vehicle can be optimized. Examples disclosed herein include a vehicle with a controller and range-detection sensors (e.g., proximity sensors, cameras). When the vehicle is in an on state (e.g., when the ignition is on) and parked, the range-detection sensors are in an active mode and collect information to monitor a surrounding area of the vehicle. Further, the controller determines a wakeup frequency for the range-detection sensors when the vehicle is in an off state. For example, the controller increases the wakeup frequency when a parking position adjustment is more likely and/or decreases the wakeup frequency when a parking position adjustment is less likely. When the vehicle is in an off state (e.g., when the ignition is off) and parked, the range-detection sensors temporarily wake up from a sleep mode at the wakeup frequency to conserve energy consumption while the vehicle is in the off state. Upon temporarily waking up, the range-detection sensors collect information to enable the controller to monitor the surrounding area. The controller determines whether the parking position of the vehicle can be optimized (e.g., to create an addition parking spot, to create a buffer zone for exiting the parking position, to reposition the vehicle to be fully within a predefined parking spot, etc.). Upon determining that the parking position of the vehicle should be adjusted, the controller sends a notification to an operator (e.g., a driver) of the vehicle and/or instructs an autonomy unit to autonomously adjust the position of the vehicle.

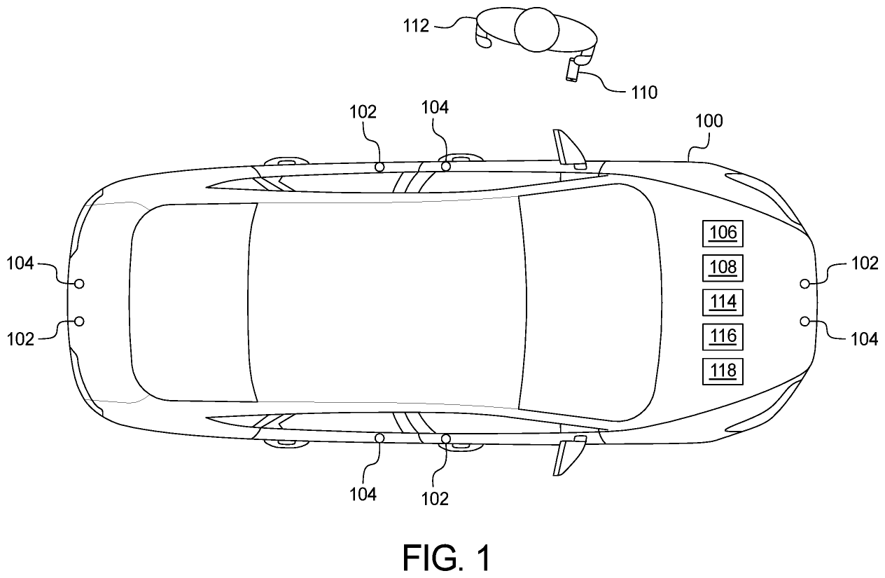

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input).

As illustrated in FIG. 1, the vehicle 100 includes range-detection sensors. As used herein, a “range-detection sensor” refers to an electronic device that is configured to collect information to detect a presence of and distance to nearby object(s). In the illustrated example, the range-detection sensors of the vehicle 100 include proximity sensors 102 and cameras 104. The proximity sensors 102 are configured to detect the presence, proximity, and/or location of object(s) near the vehicle 100. For example, the proximity sensors 102 include radar sensor(s), lidar sensor(s), ultrasonic sensor(s), and/or any other sensor configured to detect the presence, proximity, and/or location of nearby object(s). A radar sensor detects and locates an object via radio waves, a lidar sensor detects and locates the object via lasers, and an ultrasonic sensor detects and locates the object via ultrasound waves. Further, the cameras 104 capture image(s) and/or video of a surrounding area of the vehicle 100 to enable nearby object(s) to be identified and located. In the illustrated example, the range-detection sensors (e.g., the proximity sensors 102, the cameras 104) are located on each side of the vehicle 100 (e.g., front, rear, left, right) to enable the range-detection sensors in monitoring each portion of the surrounding area of the vehicle 100. In other examples, one or more of the range-detection sensors is located and/or distributed along a length and/or width of a respective side of the vehicle 100.

Further, the vehicle 100 of the illustrated example includes a global positioning system (GPS) receiver 106 and a communication module 108. The GPS receiver 106 receives a signal from a global positioning system to identify a current location of the vehicle 100. The communication module 108 includes wired or wireless network interfaces to enable communication with other devices and/or external networks. The communication module 108 also includes hardware (e.g., processors, memory, storage, antenna, etc.) and software to control the wired or wireless network interfaces.

For example, the communication module 108 includes network interface(s) configured to wirelessly communicate with a mobile device 110 (e.g., a smart phone, a wearable, a smart watch, a tablet, etc.) of a user 112 of the vehicle 100 via short-range wireless communication protocol(s). In some examples, the communication module 108 implements the Bluetooth® and/or Bluetooth® Low Energy (BLE) protocols. The Bluetooth® and BLE protocols are set forth in Volume 6 of the Bluetooth® Specification 4.0 (and subsequent revisions) maintained by the Bluetooth® Special Interest Group. Additionally or alternatively, the communication module 108 is configured to wirelessly communicate via Wi-Fi®, Near Field Communication (NFC), ultra-wide band (UWB) communication, ultra-high frequency (UHF) communication, low frequency (LF) communication, and/or any other communication protocol that enables the communication module 108 to communicatively couple with the mobile device 110.

Further, in some examples, the communication module 108 includes network interface(s) for communication with external network(s). The external network(s) may be a public network, such as the Internet; a private network, such as an intranet; or combinations thereof. The communication module 108 may utilize a variety of networking protocols now available or later developed including, but not limited to, TCP/IP-based networking protocols. For example, the communication module 108 includes one or more communication controllers for cellular networks, such as Global System for Mobile Communications (GSM), Universal Mobile Telecommunications System (UMTS), Long Term Evolution (LTE), Code Division Multiple Access (CDMA).

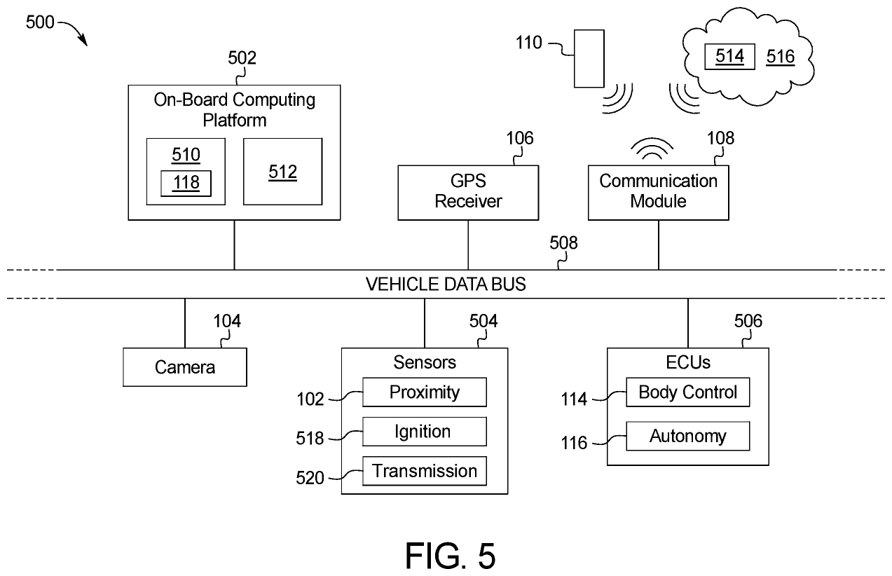

The vehicle 100 of the illustrated example also includes a body control module 114 and an autonomy unit 116. The body control module 114 is an electronic control unit (e.g., of electronic control units 506 of FIG. 5) that controls one or more subsystems throughout the vehicle 100, such as power windows, power locks, an immobilizer system, power mirrors, etc. For example, the body control module 114 includes circuits that drive one or more of relays (e.g., to control wiper fluid, etc.), brushed direct current (DC) motors (e.g., to control power seats, power locks, power windows, wipers, etc.), stepper motors, LEDs, etc. In the illustrated example, the body control module 114 includes hardware to control operation of the proximity sensors 102, the cameras 104, and/or other range-detection sensors. The autonomy unit 116 controls performance of autonomous and/or semi-autonomous driving maneuvers of the vehicle 100 based upon, at least in part, data collected by the proximity sensors 102 and/or image(s) and/or video captured by the cameras 104.

As illustrated in FIG. 1, the vehicle 100 includes a parking controller 118 that is configured to monitor and analyze parking positions while the vehicle 100 is parked at a parking spot. For example, while the vehicle 100 is parked and in an off state (also referred to as a key-off state), the parking controller 118 is configured to temporarily monitor a surrounding area of the vehicle 100 at predetermined interval(s) to determine whether the parking position of the vehicle 100 can be adjusted to optimize the parking position of the vehicle 100. Upon identifying to adjust the parking position of the vehicle 100, the parking controller 118 (1) sends a notification, via the communication module 108, to instruct the user 112 to adjust the parking position of the vehicle 100 and/or (2) sends instruction(s) to the autonomy unit 116 to cause the autonomy unit 116 to autonomously adjust the parking position of the vehicle 100.

In operation, while the vehicle 100 is (i) in an on state and (ii) parked, the parking controller 118 identifies a wakeup frequency for the range-detection sensors (e.g., the proximity sensors 102, the cameras 104) for when the vehicle 100 is in an off state. In the illustrated example, the parking controller 118 determines that the vehicle 100 is in an on state (also referred to a key-on state) when an ignition switch sensor (e.g., an ignition switch sensor 518 of FIG. 5) detects that an ignition switch is in an on position. Further, the parking controller 118 determines that the vehicle 100 is parked when a transmission sensor (e.g., a transmission sensor 520 of FIG. 5) detects that a transmission is in the park position.

When the vehicle 100 is in the on state, the range-detection sensors remain in an active state. During this time, the range-detection sensors monitor the surrounding area of the vehicle 100 to enable the parking controller 118 to generate an initial parking map of the surrounding area. For example, a parking map generated by the parking controller 118 identifies if and/or where other vehicles are parked near the current parking position of the vehicle 100. Upon generating the initial parking map, the parking controller 118 stores the initial parking map in memory (e.g., memory 512 of FIG. 5 onboard the vehicle 100).

Further, when the vehicle 100 is in the on state and parked, the parking controller 118 of the illustrated example utilizes an algorithm (e.g., a learning algorithm) to identify the wakeup frequency for the range-detection sensors for when the vehicle 100 is in the off state (e.g., due to the user 112 turning off the vehicle 100 via the ignition switch). The parking controller 118 determines the wakeup frequency based on the initial parking map and/or other characteristics of the surrounding area of the vehicle 100. In the illustrated example, the parking controller 118 is configured to determine the wakeup frequency based on the geographic location of the vehicle 100, a traffic density of the location, a parking density of the location, the time-of-day, designated locations of the user 112, etc. For example, the parking controller 118 determines the wakeup frequency of the range-detection sensors based on (1) a current parking usage and/or traffic density of the surrounding area, (2) an average parking usage and/or traffic density identifier for the vehicle location, (3) an average parking usage and/or traffic density identifier for the vehicle location for the current day and/or current time-of-day, and/or (4) whether the vehicle location corresponds with a designated geo-fenced location (e.g., a home location, a work location, etc.) of the user 112.

In some examples, the parking controller 118 (i) increases the wakeup frequency for designated location(s) (e.g., a work location, a home location, etc.) of the user 112. In other examples, the parking controller 118 identifies a wakeup frequency for the range-detection sensors only upon detecting that the vehicle 100 is at a designated location of the user 112. Further, in some examples, the parking controller 118 (i) increases the wakeup frequency for high-density traffic and/or parking locations and (ii) decreases the wakeup frequency for low-density traffic and/or parking locations to conserve energy consumption of the vehicle 100. In other examples, the parking controller 118 is configured to not determine a wakeup frequency for the range-detection sensors upon identifying that the parking location of the vehicle 100 is designated for and/or otherwise corresponds with short-term parking events (e.g., less than 15 minutes).

When the vehicle 100 is in the off state (e.g., after the user 112 transitions the ignition switch to the off position), the parking controller 118 temporarily activates the range-detection sensors at the wakeup frequency to monitor the surrounding area of the vehicle 100. Based on the information collected by the range-detection sensors, the parking controller 118 generates a current parking map of the surrounding area. Further, the parking controller 118 determines whether to adjust the parking position of the vehicle based on the current parking map and/or the information collected by the range-detection sensors. For example, the parking controller 118 determines to adjust the parking position to (1) create an additional parallel parking spot, (2) create a buffer zone for exiting the current parking spot, and/or (3) position the vehicle 100 fully within border lines defining a parking spot.

Responsive to determining that the parking position of the vehicle 100 is to be adjusted, the parking controller 118 (1) sends a notification to the user 112 (e.g., to the mobile device 110 of the user 112) via the communication module 108 and/or (2) instructs the autonomy unit 116 to perform autonomous motive function(s) to autonomously adjust the parking position of the vehicle 100. In some examples, the parking controller 118 sends the notification to the user 112 to instruct the user 112 to return to the vehicle 100 and move the vehicle 100 non-autonomously. In other examples, the parking controller 118 sends the notification to the user 112 to instruct the user 112 to return to the vehicle 100 to initiate the autonomous and/or semi-autonomous adjustment of the parking position of the vehicle 100. For example, the autonomy unit 116 is configured to adjust the parking position of the vehicle 100 in response to determining (e.g., based on received signal strength indicators (RSSI), angles-of-arrival, etc. of wireless communication) that the mobile device 110 of the user 112 is within predefined distance of the vehicle 100. Further, in other examples, the autonomy unit 116 is configured to autonomously adjust the parking position of the vehicle 100 irrespective of the location of the user 112.

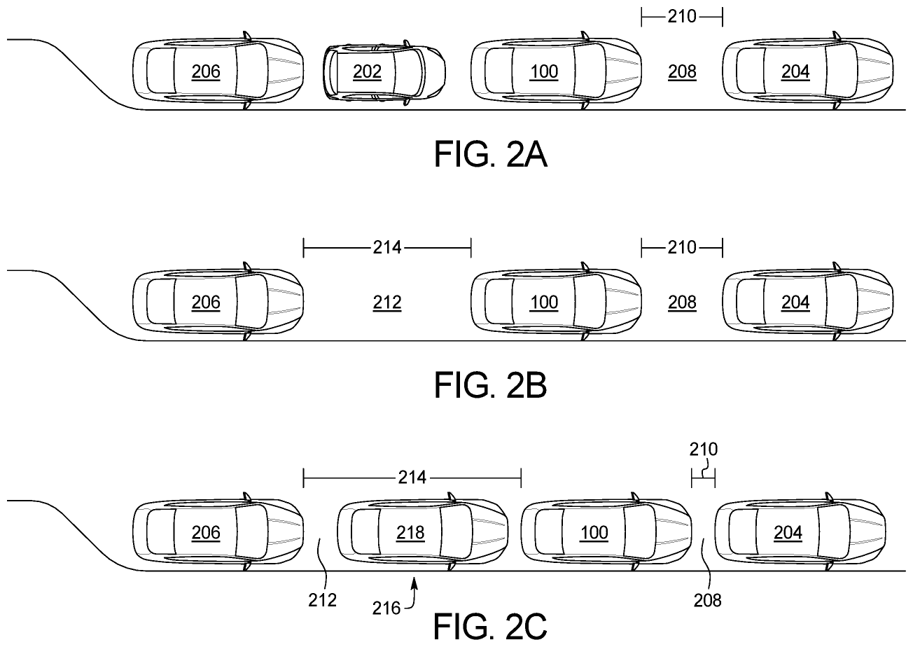

FIGS. 2A-2C depict an example parking scenario of the vehicle 100 in which the parking controller 118 is utilized to optimize the parking position of the vehicle 100. More specifically, FIGS. 2A-2C depict an example parallel parking scenario in which a parking position of the vehicle 100 is adjusted to create an additional parking spot for another vehicle. FIG. 2A, depicts a first state of the parallel parking scenario, FIG. 2B depicts a second state of the parallel parking scenario, and FIG. 2C depicts a third state of the parallel parking scenario.

FIG. 2A depicts the vehicle 100 when parked in a parallel parking spot. The vehicle is positioned between a vehicle 202 and a vehicle 204. More specifically, the vehicle 100 is parked in front of the vehicle 202 and behind the vehicle 204. Further, another vehicle 206 is parked behind the vehicle 202. As illustrated in FIG. 2A, the vehicle 202 is small. For example, the vehicle 202 is a compact vehicle. Additionally, an open space 208 is located between the vehicle 100 and the vehicle 204. In the illustrated example, the open space 208 has a length 210. The length 210 is short, such that another vehicle cannot fit in the open space 208 between the vehicle 100 and the vehicle 204. That is, the open space 208 does not form another parallel parking spot.

In FIG. 2B, the vehicle 202 has left its parking spot. In turn, an open space 212 having a length 214 is formed between the vehicle 100 and the vehicle 206. In the illustrated example, because the vehicle 202 was small, the length 214 of the open space 212 left by the vehicle 202 is short. In turn, a medium and/or large vehicle (e.g., a sedan, an SUV, a truck, etc.) cannot park within the open space 212. That is, the vehicle 100 is positioned in FIG. 2B such that (i) a vehicle 100 cannot park within the open space 208 and (ii) a medium and/or large vehicle cannot park within the open space 212.

In the illustrated example, the parking controller 118 identifies the open spaces 208, 212 and their respective lengths 210, 214 when the range-detection sensors (e.g., the proximity sensors 102, the cameras 104) wake up at the wakeup frequency. That is, when the vehicle 100 is parked in a parallel parking position, the parking controller 118 is configured to determine, via the range-detection sensors, the length 210 of the open space 208 in front of the vehicle 100 and the length 214 of the open space 212 behind the vehicle 100. Further, the parking controller 118 is configured to determine whether adjusting the parking position of the vehicle 100 will create an additional parking spot (e.g., for a small, medium, and/or large vehicle). For example, the parking controller 118 determines that an additional parking spot can be created by adjusting the parking position of the vehicle 100 if the sum of the length 210 and the length 214 equals and/or exceeds a predefined length of a standard parking spot. That is, the parking controller 118 determines to adjust the parking position of the vehicle 100 to create an additional parking spot in response to identifying that (1) moving the vehicle 100 forward increases the length 214 to equal or exceed the predefined length and/or (2) moving the vehicle in reverse increases the length 210 to equal or exceed the predefined length.

FIG. 2C depicts the vehicle 100 after the vehicle 100 has been moved forward (e.g., non-autonomously by the user 112, autonomously by the autonomy unit 116) to create an additional parking spot 216 behind the vehicle 100 for another vehicle 218. As illustrated in FIG. 2C, the vehicle 100 has moved such that (i) the length 210 of the open space 208 has reduced and (ii) the length 214 of the open space 212 has increased. For example, the length 214 of the open space 212 has increased to equal or exceed a predefined length of a standard parking spot.

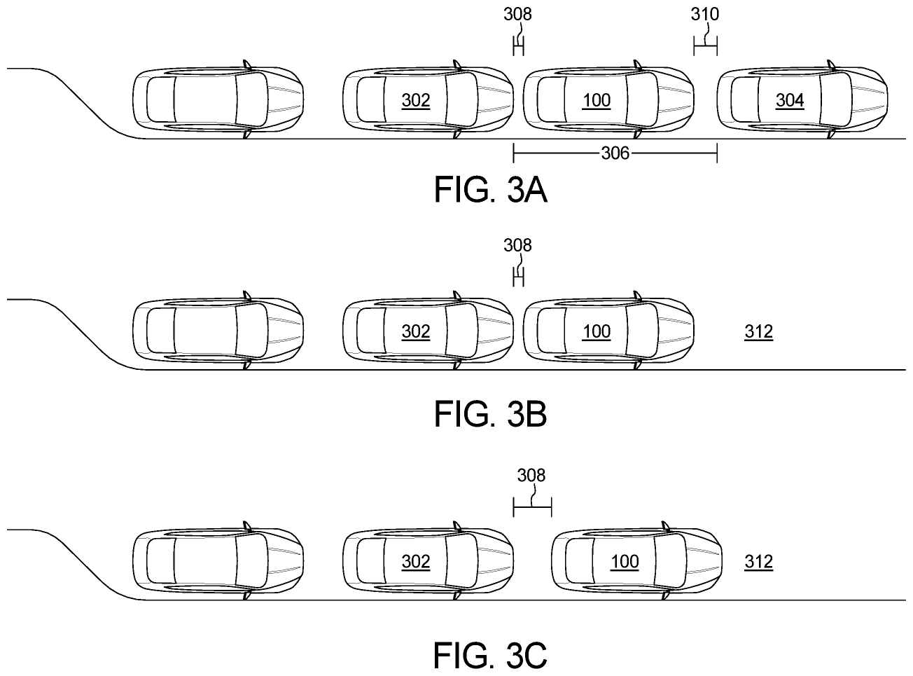

FIGS. 3A-3C depict another example parking scenario of the vehicle 100 in which the parking controller 118 is utilized to optimize the parking position of the vehicle 100. More specifically, FIGS. 3A-3C depict an example parallel parking scenario in which a parking position of the vehicle 100 is adjusted to create a buffer to facilitate the vehicle 100 in exiting the parking position at a later time. FIG. 3A, depicts a first state of the parallel parking scenario, FIG. 3B depicts a second state of the parallel parking scenario, and FIG. 3C depicts a third state of the parallel parking scenario.

FIG. 3A depicts the vehicle 100 when parked in a parallel parking spot. The vehicle is positioned between a vehicle 302 and a vehicle 304. More specifically, the vehicle 100 is parked in front of the vehicle 302 and behind the vehicle 304. As illustrated in FIG. 3A, the vehicle 302 and the vehicle 304 define a length 306 of the parallel parking spot of the vehicle 100. Further, the vehicle 100 is position in the parking spot such that (i) an open space between the vehicle 100 and the vehicle 302 has a length 308 and (ii) an open space between the vehicle 100 and the vehicle 304 has a length 310. As illustrated in FIG. 3A, the length 308 and the length 310 are small such that it is potentially difficult for the vehicle 100 to leave its parking spot.

In the illustrated example, the parking controller 118 of the vehicle 100 identifies the lengths 308, 310 of the open spaces adjacent the vehicle 100 when the range-detection sensors (e.g., the proximity sensors 102, the cameras 104) wake up at the wakeup frequency. That is, when the vehicle 100 is parked in a parallel parking position, the parking controller 118 is configured to determine, via the range-detection sensors, the length 308 of the open space behind the vehicle 100 and the length 310 of the open space in front of the vehicle 100.

In FIG. 3B, the vehicle 304 has left a parking spot 312 at which the vehicle 304 was previously parked. In the illustrated example, the parking controller 118 of the vehicle 100 is configured to identify that the vehicle 304 has left the parking spot 312 when the range-detection sensors wake up at the wakeup frequency. Further, the parking controller 118 is configured to determine whether to adjust the parking position of the vehicle 100 to create a buffer distance between the vehicle 100 and the vehicle 302 that facilitates the vehicle 100 in leaving its parking spot at a later time.

For example, the parking controller 118 is configured to identify whether the vehicle 100 is able to move in reverse to increase the length 310 of the open space in front of the vehicle 100 to a predefined buffer distance without decreasing the length 308 behind the vehicle 100 to be less than a predefined length corresponding with a standard parking spot. If the vehicle 100 is able to do so, the parking controller 118 determines to move the vehicle 100 in reverse to create a buffer distance in front of the vehicle 100. In the illustrated example of FIG. 3B, the parking controller 118 identifies that the vehicle 100 is able to move forward to increase the length 308 of the open space behind the vehicle 100 to a predefined buffer distance without decreasing a length of the parking spot 312 to be less than a predefined length corresponding with a standard parking spot. In turn, the parking controller 118 determines to move the vehicle 100 forward to create a buffer distance behind the vehicle 100.

FIG. 3C depicts the vehicle 100 after the vehicle 100 has been moved forward (e.g., non-autonomously by the user 112, autonomously by the autonomy unit 116) to create a buffer distance between the vehicle 100 and the vehicle 302. As illustrated in FIG. 3C, the vehicle 100 has moved such that (i) the length 308 of the open space behind the vehicle 100 equals a buffer distance and (ii) the parking spot 312 in front of the vehicle 100 has a length that equals or exceeds that of a standard parking spot (e.g., for a medium-sized vehicle).

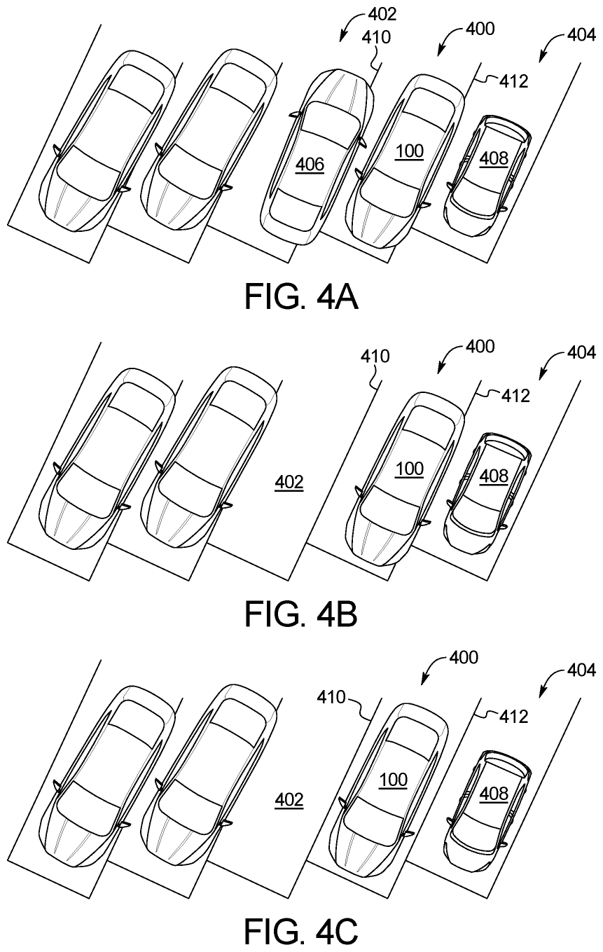

FIGS. 4A-4C depict another example parking scenario of the vehicle 100 in which the parking controller 118 is utilized to optimize the parking position of the vehicle 100. More specifically, FIGS. 4A-4C depict an example parking scenario in which a parking position of the vehicle 100 is adjusted to fit completely within a parking spot (e.g., an angled parking spot). FIG. 4A, depicts a first state of the parking scenario, FIG. 4B depicts a second state of the parking scenario, and FIG. 4C depicts a third state of the parking scenario.

In FIG. 4A, the vehicle 100 is parked partially within a parking spot 400 (e.g., an angled parking spot) that is positioned between a parking spot 402 (e.g., an angled parking spot) bordering one side of the parking spot 400 and a parking spot 404 (e.g., an angled parking spot) bordering another side of the parking spot 400. Further, a vehicle 406 is parked partially within the parking spot 402, and a vehicle 408 is parked within the parking spot 404. That is, the vehicle 406 extends over a border line 410 between the parking spot 402 and the parking spot 400, and the vehicle 100 extends over a border line 412 between the parking spot 400 and the parking spot 404. For example, the vehicle 100 may be positioned over the border line 412 due to the vehicle 406 being positioned over the border line 410 when the vehicle parked (partially) within the parking spot 400.

In the illustrated example, the parking controller 118 of the vehicle 100 monitors the parking spots 400, 402, 404 when the range-detection sensors (e.g., the proximity sensors 102, the cameras 104) wake up at the wakeup frequency. For example, the parking controller 118 determines whether (i) the vehicle 100 is positioned fully within the parking spot 400, (ii) a vehicle (e.g., the vehicle 406) is positioned (fully or partially) within the parking spot 402, and (iii) a vehicle (e.g., the vehicle 408) is positioned (fully or partially) within the parking spot 404.

In FIG. 4B, the vehicle 406 has left the parking spot 402. In the illustrated example, the parking controller 118 of the vehicle 100 identifies that the vehicle 406 has left the parking spot 402 when the range-detection sensors wake up at the wakeup frequency. That is, the parking controller 118 is configured to determine when the parking spot 402 and/or the parking spot 404 is unoccupied. Further, the parking controller 118 is configured to determine whether the vehicle 100 is positioned fully within the border lines 410, 412 of the parking spot 400. In response to determining that (1) the parking spot 402 and/or the parking spot 404 is unoccupied and (2) the vehicle 100 is not positioned fully within the border lines 410, 412 of the parking spot 400, the parking controller 118 determines that the parking position of the vehicle 100 is to be adjusted to position the vehicle 100 fully within the parking spot 400. In the illustrated example, the parking controller 118 determines to adjust the parking position of the vehicle 100 such that the vehicle 100 does not extend over the border line 412 in response to determining that (1) the parking spot 402 is unoccupied and (2) the vehicle 100 extends over the border line 412 of the parking spot 400.

FIG. 4C depicts the vehicle 100 after the parking position of the vehicle 100 has been adjusted (e.g., non-autonomously by the user 112, autonomously by the autonomy unit 116) to be fully within the parking spot 400. In the illustrated example, the autonomy unit 116 is configured to autonomously perform reverse, turning, and forward motive functions to reposition the vehicle 100 fully within the parking spot 400. For example, to reposition the vehicle 100 fully within the parking spot 400, the autonomy unit 116 moves the vehicle 100 in reverse to back out of the parking spot 400, turns the vehicle 100 while moving forward into the parking spot 400, and straightens out while continuing to move forward to a parked position.

FIG. 5 is a block diagram of electronic components 500 of the vehicle 100. As illustrated in FIG. 5, the electronic components 500 include an on-board computing platform 502, the GPS receiver 106, the communication module 108, the cameras 104, sensors 504, electronic control units (ECUs) 506, and a vehicle data bus 508.

The on-board computing platform 502 includes a processor 510 (also referred to as a microcontroller unit and a controller) and memory 512. In the illustrated example, the processor 510 of the on-board computing platform 502 is structured to include the parking controller 118. In other examples, the parking controller 118 is incorporated into another ECU with its own processor and memory. The processor 510 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 512 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 512 includes multiple kinds of memory, particularly volatile memory and non-volatile memory.

The memory 512 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 512, the computer readable medium, and/or within the processor 510 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the communication module 108 is configured to wirelessly communicate with the mobile device 110 of the user 112 and/or a remote server 514 via a network 516. For example, the communication module 108 communicates with the mobile device 110 to provide a notification to the user 112 to move the parking position of the vehicle 100. Additionally or alternatively, the communication module 108 communicates with the mobile device 110 to determine (e.g., via received signal strength indication (RSSI), angle-of-arrival, etc.) that the user 112 is within a predetermined distance of the vehicle 100 required to initiate remote park-assist features. Further, the communication module 108 communicates with the remote server 514 to identify parking characteristics of the current parking location of the vehicle 100. For example, the parking controller 118 identifies (1) whether the current parking location is a location (e.g., a home location, a work location, a high-traffic area, a high-density parking area, etc.) that has been designated (e.g., by the user 112) for monitoring the surrounding parking area, (2) an average parking-usage and/or traffic-density identifier for the current parking location, (3) an average parking-usage and/or traffic-density identifier for the current parking location at the current time, (4) a current parking-usage and/or traffic-density identifier for the current parking location at the current time, etc.

The sensors 504 are arranged in and/or around the vehicle 100 to monitor properties of the vehicle 100 and/or an environment in which the vehicle 100 is located. One or more of the sensors 504 may be mounted to measure properties around an exterior of the vehicle 100. Additionally or alternatively, one or more of the sensors 504 may be mounted inside a cabin of the vehicle 100 or in a body of the vehicle 100 (e.g., an engine compartment, wheel wells, etc.) to measure properties in an interior of the vehicle 100. For example, the sensors 504 include accelerometers, odometers, tachometers, pitch and yaw sensors, wheel speed sensors, microphones, tire pressure sensors, biometric sensors and/or sensors of any other suitable type. In the illustrated example, the sensors 504 include the proximity sensors 102, an ignition switch sensor 518 to detect an operating state of the vehicle 100 (e.g., a key-off state, a key-on state), and a transmission sensor 520 to detect a position of the transmission of the vehicle 100. For example, the transmission sensor 520 detects when the vehicle 100 is in park.

The ECUs 506 monitor and control the subsystems of the vehicle 100. For example, the ECUs 506 are discrete sets of electronics that include their own circuit(s) (e.g., integrated circuits, microprocessors, memory, storage, etc.) and firmware, sensors, actuators, and/or mounting hardware. The ECUs 506 communicate and exchange information via a vehicle data bus (e.g., the vehicle data bus 508). Additionally, the ECUs 506 may communicate properties (e.g., status of the ECUs 506, sensor readings, control state, error and diagnostic codes, etc.) to and/or receive requests from each other. For example, the vehicle 100 may have dozens of the ECUs 506 that are positioned in various locations around the vehicle 100 and are communicatively coupled by the vehicle data bus 508. In the illustrated example, the ECUs 506 include the body control module 114 and the autonomy unit 116.

The vehicle data bus 508 communicatively couples the cameras 104, the GPS receiver 106, the communication module 108, the on-board computing platform 502, the sensors 504, and the ECUs 506. In some examples, the vehicle data bus 508 includes one or more data buses. The vehicle data bus 508 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

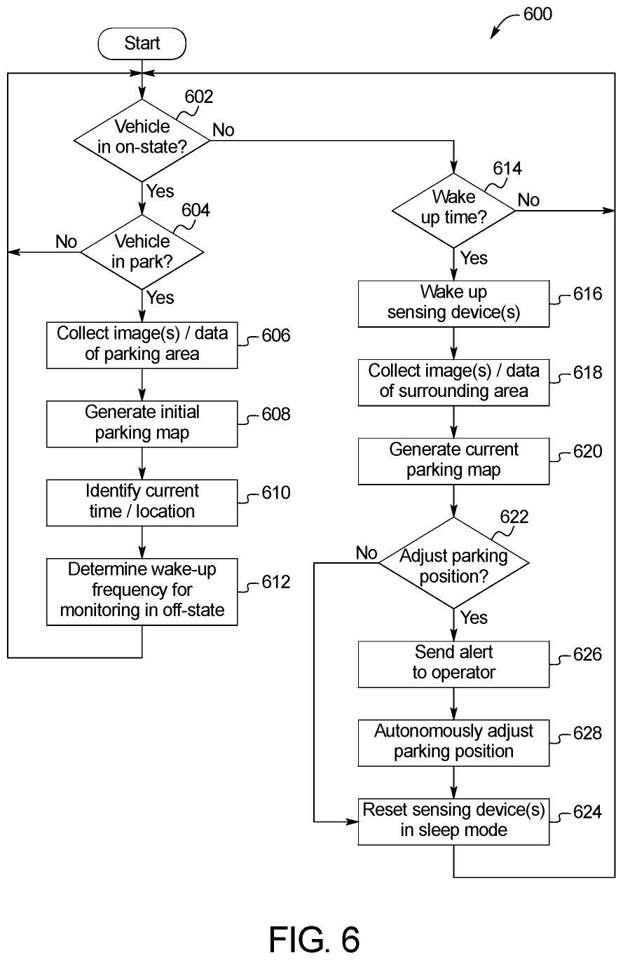

FIG. 6 is a flowchart of an example method 600 to monitor and adjust a parking position of a vehicle. The flowchart of FIG. 6 is representative of machine readable instructions that are stored in memory, such as the memory 512 of FIG. 5, and include one or more programs which, when executed by a processor, such as the processor 510 of FIG. 5, cause the vehicle 100 to implement the example parking controller 118 of FIGS. 1 and 5. While the example program is described with reference to the flowchart illustrated in FIG. 6, many other methods of implementing the example parking controller 118 may alternatively be used. For example, the order of execution of the blocks may be rearranged, changed, eliminated, and/or combined to perform the method 600. Further, because the method 600 is disclosed in connection with the components of FIGS. 1-5, some functions of those components will not be described in detail below.

Initially, at block 602, the parking controller 118 determines whether the vehicle 100 is in an on-state. For example, the parking controller 118 determines an operating state of the vehicle 100 based on a position of an ignition switch as detected by the ignition switch sensor 518. In response to the parking controller 118 determining that the vehicle 100 is in the on-state, the method 600 proceeds to block 604 at which the parking controller 118 determines whether the vehicle 100 is in park. For example, the parking controller 118 collects a position of the transmission from the transmission sensor 520. In response to the parking controller 118 determining that the vehicle 100 is not in park (e.g., is in drive, reverse, etc.), the method 600 returns to block 602. Otherwise, in response to the parking controller 118 determining that the vehicle 100 is in park, the method 600 proceeds to block 606.

At block 606, the parking controller 118 collects information of the surrounding area in which the vehicle 100 is parked. For example, the collects image(s) and/or video from the cameras 104, data from the proximity sensors 102, and/or other information from other range-detection sensors of the vehicle 100. At block 608, the parking controller 118 generates an initial parking map of the surrounding area of the vehicle 100. For example, the parking map identifies other parking spot(s) and/or parked vehicle(s) near the parked location of the vehicle 100. At block 610, the parking controller 118 identifies a current time and/or geographic location of the vehicle 100. Further, in some examples, the parking controller 118 collects other information of the surrounding area (e.g., from the remote server 514), such as parking usage, traffic density, work and/or home designation(s) of the user 112, etc., based on the current time and/or geographic location of the vehicle 100. At block 612, the parking controller 118 determines a wakeup frequency for the range-detection sensors to monitor the surrounding area when the vehicle 100 is in the off-state.

Returning to block 602, in response to the parking controller 118 determining that the vehicle 100 is not in the on-state (e.g., is in the off-state), the method 600 proceeds to block 614 at which the parking controller 118 determines whether it is a wakeup time for the range-detection sensors of the vehicle 100 from a sleep mode. The parking controller 118 determines whether it is time to wake up the range-detection sensors based on the wakeup frequency determined at block 612. In response to the parking controller 118 determining that it is not time to wake up the range-detection sensors, the method 600 returns to block 602. Otherwise, in response to the parking controller 118 determining that it is time to wake up the range-detection sensors, the method 600 proceeds to block 616.

At block 616, the parking controller 118 wakes up the range-detection sensors (e.g., the proximity sensors 102, the cameras 104) and/or other sensing devices of the vehicle 100 from a sleep mode. For example, the parking controller 118 instructs the body control module 114 to wake up the range-detection sensors of the vehicle 100. At block 618, the parking controller 118 collects information of the surrounding area of the vehicle 100 from the range-detection sensors. For example, the parking controller 118 obtains data collected by the proximity sensors 102 and/or image(s) and/or video captured by the cameras 104. At block 620, the parking controller 118 generates a current parking map of the surrounding area of the vehicle 100 based on the collected information.

At block 622, the parking controller 118 determines whether the parking position of the vehicle 100 is to be adjusted based on the current parking map. For example, the parking controller 118 determines to adjust the parking position of the vehicle 100 to (1) create an additional parallel parking spot, (2) create a buffer zone for exiting a parallel parking spot, (3) reposition within the lines of a parking spot (e.g., parallel, perpendicular, angled), etc.

In response to the parking controller 118 determining that the parking position of the vehicle 100 is not to be adjusted, the method 600 proceeds to block 624 at which the parking controller 118 resets the range-detection sensors and/or other sensing devices in a sleep mode. For example, the parking controller 118 sends an instruction to the body control module 114 to resets the sensing devices in a sleep mode. Upon completing block 624, the method 600 returns to block 602.

Otherwise, in response to the parking controller 118 determining that the parking position of the vehicle 100 is to be adjusted, the method 600 proceeds to block 626 at which the parking controller 118 sends an alert to the user 112 to adjust the parking position of the vehicle 100. For example, the parking controller 118 sends the alert to the mobile device 110 of the user 112 via the communication module 108. At block 628, the autonomy unit 116 autonomously adjusts the parking position of the vehicle 100. For example, the parking controller 118 wakes up the vehicle 100 and instructs the autonomy unit 116 to perform autonomous motive functions based on information collected by the range-detection sensors. Upon completing block 628, the method 600 proceeds to block 624 at which the parking controller 118 resets the sensing devices of the vehicle 100 into a sleep mode.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module” and “unit” refer to hardware with circuitry to provide communication, control and/or monitoring capabilities. A “module” and a “unit” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
range-detection sensors;
a communication module; and
a controller to:
identify a wakeup frequency for the range-detection sensors;
when the vehicle is in a key-off state, temporarily activate the range-detection sensors at the wakeup frequency and determine whether to adjust a parking position based on the range-detection sensors; and
responsive to determining to adjust the parking position, send a notification to a user via the communication module.

2. The vehicle of claim 1, further including an ignition switch sensor to detect an operating state of the vehicle.

3. The vehicle of claim 1, wherein the controller is configured to identify the wakeup frequency when the vehicle is in park and in a key-on state.

4. The vehicle of claim 3, further including a transmission sensor to detect when the vehicle is in park.

5. The vehicle of claim 1, wherein one or more of the range-detection sensors is selected from a group consisting of a proximity sensor and a camera.

6. The vehicle of claim 1, further including a GPS receiver to identify a vehicle location, wherein the controller determines the wakeup frequency for the range-detection sensors based on the vehicle location.

7. The vehicle of claim 6, wherein the controller is configured to increase the wakeup frequency for high-traffic areas and decrease the wakeup frequency for low-traffic areas.

8. The vehicle of claim 7, wherein the communication module is configured to communicate with a remote server to identify a traffic density of the vehicle location.

9. The vehicle of claim 6, wherein the controller is configured to increase the wakeup frequency when the vehicle location corresponds with at least one of a home location and a work location of the user.

10. The vehicle of claim 6, wherein the controller determines the wakeup frequency for the range-detection sensors further based on a time-of-day.

11. The vehicle of claim 1, further including an autonomy unit to perform autonomous motive functions to adjust the parking position of the vehicle.

12. The vehicle of claim 11, wherein the autonomy unit is configured to adjust the parking position in response to the user returning within a predetermined distance of the vehicle after receiving the notification.

13. The vehicle of claim 1, wherein, when the parking position is a parallel parking position, the controller is configured to determine, via the range-detection sensors, a first length of a first open space behind the vehicle and a second length of a second open space in front of the vehicle.

14. The vehicle of claim 13, wherein the controller determines to adjust the parking position to create an additional parking spot in response to identifying that moving the vehicle forward or in reverse increases the first length or the second length to equal or exceed a predefined length of a standard parking spot.

15. The vehicle of claim 13, wherein the controller determines to adjust the parking position to increase a buffer distance in response to identifying that moving the vehicle forward or in reverse increases the first length or the second length to equal the buffer distance without decreasing the other of the first length or the second length below a predefined length of a standard parking spot.

16. The vehicle of claim 1, wherein, when the parking position corresponds with a perpendicular or angled parking spot, the controller is configured to monitor bordering parking spots via the range-detection sensors.

17. The vehicle of claim 16, wherein the controller determines to adjust the parking position in response to determining:
at least one of the bordering parking spots is unoccupied; and
the vehicle is not positioned fully within border lines of the perpendicular or angled parking spot.

18. The vehicle of claim 17, further including an autonomy unit configured to autonomously perform reverse, turning, and forward motive functions to reposition the vehicle fully within the perpendicular or angled parking spot.

19. A method comprising:
identifying, via a processor, a wakeup frequency for range-detection sensors of a vehicle;
when the vehicle is in a key-off state, temporarily activating the range-detection sensors at the wakeup frequency;
determining whether to adjust a parking position of the vehicle based on the range-detection sensors; and
sending, via a communication module of vehicle, a notification to a user responsive to determining to adjust the parking position.

20. The method of claim 19, wherein the wakeup frequency for the range-detection sensors is determined based on a current location of the vehicle.
